(19) United States
(12) Patent Application Publication
(10) Pub. No.: US 2005/0081694 A1
(43) Pub. Date: Apr. 21, 2005

(54) Automated punch machine for perforating stacks of sheets

(75) Inventors: Samuel P. Amdahl, Arlington Heights, IL (US); Peter Hotkowski, Chester, CT (US); James Russo, Chicago Heights, IL (US); Frank Todaro, Old Saybrook, CT (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: General Binding Corporation, Northbrook, IL (US)

(21) Appl. No.: 10/970,770

(22) Filed: Oct. 21, 2004

Related U.S. Application Data
(63) Continuation of application No. PCT/US03/12304, filed on Apr. 22, 2003.
(60) Provisional application No. 60/374,428, filed on Apr. 22, 2002.

(51) Int. Cl. B26D 5/08; B26D 1/12

(52) U.S. Cl. 83/669

(57) ABSTRACT

An automated punching arrangement for punching successive sheets or lifts from an input stack of sheets, and arranging those sheets in an output stack. The automated punching arrangement receives the stack at an input platform that automatically advances the stack into the machine where a picker picks a sheet or successive lifts from the stack and delivers them along an input path into direct registration in a die set. Punched sheets are advanced out of the punch at a 90° angle from the input path along an output path, and inverted by an inverter to the output stack on an output platform. The punched stack of sheets is then advanced out of the machine. The machine includes automated set up including reading of dedicated identifying markers on die sets and resulting adjustment of the die set position within the machine and of the back plate within the die set.

### CROSS REFERENCE TO RELATED PATENT APPLICATIONS

This application is a continuation of International Patent Application No. PCT/US2003/012304 filed Apr. 22, 2003, which claims priority to U.S. Provisional Patent Application No. 60/374,428 filed Apr. 22, 2002.

### FIELD OF THE INVENTION

The invention relates generally to automated punching machines for perforating stacks of sheets. More particularly, the invention relates to a fully automated machine for processing a stack of sheets to punch individual lifts therefrom.

### BACKGROUND OF THE INVENTION

In the paper finishing industry, sheet stacks are transferred between processing equipment as various steps are performed on the stacks of sheets. This transfer is typically classified as “in-line” or “off-line,” and sometimes “near-line.”

“In-line” refers to two pieces of processing equipment having their paper paths joined together such that individual sheets are passed from one system to the other sequentially and processed as such. While there are many examples of such “in-line” processing, one such prominent example is designed following the Xerox DFA (Digital Finishing Architecture) Standard. The DFA protocol spells out mechanical and software specifications for attaching finishing machinery to DFA compatible Xerox sheet printers. Many vendors make secondary equipment to create systems using this standard, including Standard Finishing, C. P. Bourg, Duplo, and others.

“In-line” systems are advantageous in that they require minimal operator interaction, and therefore, have lower overhead and least opportunity for operator error. The entire system is locked in a one-to-one speed relationship, however, limiting the performance of the entire system to that of the slowest component. Accordingly, a major disadvantage of the “in-line” system is the lack of a buffer to allow for continued processing by some portions of the system if other portions of the system temporarily cease operations. Another disadvantage is reduced versatility from two types of processing modules that are complexly coupled, inhibiting their separate use for other functions.

“Off-line” refers to sheets being transferred in some non-automatic fashion, usually in stacks of sheets. Examples include simple carts to and from which sheet stacks are manually transferred by an operator. “Off-line” systems have the advantage of being able to match a slower module to a faster device, optimizing overall performance. Additionally, the components of such “off-line” processing are not tightly coupled, allowing for more versatile use of each module. “Off-line” processing, however, necessarily requires greater operator interaction than “in-line” processing, increasing labor costs as well as the opportunity for operator error in the form of both mechanically damaged sheet stacks or movement of the stacks out of sequence, when sequence is important.

“Near-line” refers to a special case of “off-line” processing where the carts are more elaborate and custom mated to automatically receive and discharge sheet stacks. It is commonly accepted that a throughput ratio of 2:1 or greater may be matched with such near-line processing. The stacks may be electronically tracked to ensure sequence of processing, as disclosed in U.S. Pat. No. 6,192,295 BI to Gunther. One example of this type of “near-line” processing is marketed by GTI. In the GTI cart system, stacks are laid on a cart and the cart is manually rolled to a feeder. The GTI cart is designed to custom mate to the GTI stacker and GTI feeder. Although operator error is less than the opportunity with true “off-line” the chance is not eliminated. The GTI cart has a clamping system that secures the stacks from movement, however, the system requires considerable operator effort to operate.

Automatic die-punching machines have been utilized in both “off-line” and “near-line” arrangements to punch regular, repeating patterns of holes through stacks of paper sheets in preparation for binding. Typically, such a machine receives a stack and actuates die pins to punch the appropriate holes through each sheet in the stack or lift at once. The pins are then reset to punch holes in another stack. Since printing or document reproduction businesses, often handle particular binding jobs consisting of a large number of thick stacks, a principal advantage of automatic die-punching machines is their capacity to efficiently perform a uniform, repetitive, high speed punching operation, potentially requiring a high punching force, on a collection of stacks that is fed into the machine.

Although automatic die-punching machines improve the punching process, regular die maintenance or changing the machine's punching parameters for particular punching jobs can be a time-consuming process requiring disassembly of the machine. For example, the size or arrangement of holes, and the number of sheets per stack vary widely among punching jobs, requiring particular configurations or locations of die pins. Also, the service life of die pins varies inversely with frequency of their use. As a result, frequent modification of the punching parameters or regular die pin maintenance requires stopping the machine for disassembly, thus decreasing efficiency of the machine.

Mitigation of these difficulties has been attempted. For example, U.S. Pat. No. 6,047,623 (the '623 patent) to Whiteman, et al., describes an “improved die assembly and mounting means, allowing the die assembly to be quickly installed and removed without bolts, screws, or housing panel removal.” According to the disclosure, “the die assembly need not be bolted to the machine frame . . . and may be quickly removed simply by being unclamped . . . and slid out of the machine housing.” This construction of such devices allows quick and easy maintenance and changeover of the die pins, although it is subject to a number of associated shortcomings.

In particular, the '623 patent fails in its entirety to address the proper positioning of a die assembly within the machine. Placement of the holes along the edge of a stack of sheets includes the considerations not only of centering the holes along the length and insuring that no partial holes are made along the edge of the stack, but also placing the holes the desired distance from the edge of the stack of sheets. The desired hole placement in a paper will be dependent upon not only the size, shape, number, and positioning of the holes, but also the size of the paper itself. Machines in the industry, including that disclosed in the '623 patent, require further manual adjustments in order to account for these considerations. Proper location and placement of the punch in more complex, automated punching machines is further complicated by the sheer size and mechanical functions involved in punching stacks of sheets.

The punch may be structured such that the die set is disposed along the sheet path or in the sheet path. In arrangements where the die set is disposed along the sheet path, the sheet or stack of sheets advance along the sheet path with a side edge of the sheets stopping at the die set, the side edge of the sheets being disposed in the die set. Following the punch action, the sheets continue along the sheet path. In contrast, in arrangements where the die set is disposed in the sheet path, typically, the leading edge of the sheets registers within the die set as it hits a stop, arresting forward movement. Following the punching action, the stop is mechanically moved, and the sheets continue through the open die set.

Both of these arrangements have their limitations and disadvantages, however. For example, in arrangements where the die set is disposed along the sheet path, undesirable catch points can inhibit proper sheet flow. Moreover, the momentum developed in the sheets as they move along the sheet path can cause the sheets to skew in the die set, resulting in poor registration. While die sets disposed in the sheet path may provide better registration, die sets used in such arrangements must be more rigid than die sets disposed along the sheet path. Further, changing out such die sets can be complicated, time consuming and laborious.

### OBJECTS AND BRIEF SUMMARY OF THE INVENTION

It is a primary object of this invention to provide a fully automated punch machine for processing a large stack of sheets, wherein the punch machine provides a truly “near-line” processing. A related object is to provide a punch machine which requires minimum operator intervention.

Another object of the invention is to provide a punch machine that is convenient to operate and requires minimum operator intervention. A related object is to provide such a machine that may process not only a given stack of sheets, but also successive stacks of sheets without operator intervention.

An additional object is to provide a punch machine that provides enhanced operator safety. A related object is to provide a punch machine that operates in a closed environment once the sheet stack is placed at the machine by the user.

A further object of the invention is to provide a punch machine that minimizes the opportunity for operator error in setup, providing die set recognition and fully automatic setup. A related object is to provide a punch machine that automatically provides proper placement of perforations in a stack of sheets upon entry or reading of punch type and paper size.

An additional object of the invention is to provide a punch machine that minimizes jams and provides smooth movement and processing of successive lifts from a stack of sheets. A related object is to provide a punch machine that alerts the operator to potential problems in the system.

A further object of the invention is to provide a punch machine that operates in an entirely automated and enclosed atmosphere from receipt of a stack of sheets to be punched to delivery of a punched stack of sheets in the same order.

Yet another object of the invention is to provide a punch machine that readily and quickly interfaces with a mobile unit for transfer and maintenance of a stack of sheets to be processed and a processed stack of sheets.

Still a further object of the invention is to provide an automated punch machine that may be engaged with other processing machines in an “in-line” arrangement for processing stacks of sheets.

In accordance with these and other features of the invention, there is provided a punch machine that requires minimal or no intervention by an operator in order to process successive stacks of sheets. The machine includes a significantly enclosed housing having two retractable doors for input and output adjacent input and output platforms extending from the housing. The input and output platforms have alternating finger(s) and slot(s), a plurality of belts extending longitudinally about the fingers or other movement arrangement disposed to move stacks of sheets on the platforms in and out of the machine. Similar finger(s) and slot(s) or other movement arrangement from a movable cart may mate with the input and output platforms of the machine to provide easy handling of stacks of sheets. In operation, a stack of sheets is placed on the input platform. At an appropriate time, the retractable input door opens, and the belts or other movement arrangement are activated to move the stack along the platform into the machine to an input elevator having similar engaging fingers disposed between the slots of the rotating belts or alternate engaging arrangement disposed to elevate the stack. A similar output elevator platform is provided adjacent the output of the machine, only instead of feeding the stack of sheets into the machine for processing as in the input elevator, the output elevator receives the processed sheets, moving downward as the output stack increases, and eventually moving the completed output stack from the elevator past the open retractable output door to the output platform.

In processing, the input elevator is driven upward until a sensor is actuated to slow the upward movement of the input elevator. Successive lifts are then picked from the stack and moved along a transport to a punch station. The picker may be set up to lift varied numbers of sheets in a single lift, dependent upon the thickness of the sheets themselves. Such lifts are preferably of a thickness between 20 to 50 thousandths of an inch, which is typically between 4-12 sheets, depending upon sheet thickness, but may range from as little as one sheet to as many as 15 or 20 sheets. In this regard, the lift arrangement preferably provides two sensors, the first of which provides a zeroing effect, and the second of which, a Hall effect potentiometer, measures the thickness of the lift as the elevator continues to move the stack of sheets upward.

The sheet path through the machine is preferably that of an “L” shape or the like such that that stack of sheets moves along one leg of the “L” to affirmatively register in the proper position in the die set. Once dropped into the punch station, various alignment features are actuated to align the lift and feed it into the throat of the die set. After punching, the stack of sheets then moves out of the die set in a substantially perpendicular direction, along the other leg of the “L.” In this way, the punching arrangement provides the positive registration features of a die set arrangement that passes the sheets through the die set, while providing the versatility of a die set disposed along the sheet path in the direction of travel. While the preferred embodiment of the invention has the input and output legs of the sheet path disposed at a substantially right angle, it will be appreciated that the legs could alternately be disposed at essentially any angle less than approximately 135° and greater than approximately 45°, so long as the sheets are provided with positive registration at the punch rather than passing along or physically through the punch.

The die set itself includes automatic alignment and positional features that digitally control both the location of the punched holes and the depth of the throat based upon the configurations of the die set and the paper. In initial setup, the die set is slid into an initial feed position at which point a flange or the like on the die set is affirmatively engaged with the machine, and the machine then automatically continues the machine setup for the given die set loaded. In this regard, individual die sets are provided with a bar code or other identifying arrangement, and the machine is provided with an appropriate reader. From the initial position, the machine then draws the die set across the reader and provides a signal to the machine controls to adjust the other features of the machine for the die set loaded. Thus, the machine automatically adjusts not only to the size of paper, but also to the die set, and therefore, punch arrangement provided.

After punching, the lift is transported to an inverter, where it is inverted to an output stack as described above. Safety features are likewise provided at both the inverter and the output stack to ensure proper sheet movement through the system. In this regard, a sensor is likewise provided at the output stack to sense if a problem occurs at the output stack, stopping the machine and alerting the operator in such a case.

Thus, the machine provides minimal necessity for operator intervention, as well as minimal opportunity for operator or other error. Importantly, the machine includes buffering features whereby a stack of sheets may be waiting to be processed on the input platform while a completed stack is seated on the output platform, and a third stack is being processed within the machine itself. Thus, the operator is free to safely load and unload the stacks of sheets as his schedule permits. Moreover, the punch machine requires no specialized or devoted cassettes or the like for ushering the stack of sheets through the system.

These and other objects and advantages of the invention as well as additional innovative features will be apparent from the description of the invention provided herein.

### BRIEF DESCRIPTION OF THE DRAWINGS

FIG. 1 is a perspective view of an automated punch machine in accordance with teachings of the invention.

FIG. 2 is an exemplary movable cart constructed in accordance with teachings of the invention.

FIG. 3 is the punch machine of FIG. 1 partially broken away to show operations performed therein.

FIG. 4 is a top plan view of the punch machine of FIG. 1 with the top portion of the housing removed to show the inner station of the machine.

FIGS. 5a-c are fragmentary, perspective views of a pick assembly constructed in accordance with teachings of the invention at various stages of operation.

FIG. 6 is a fragmentary, perspective view of a punch station constructed in accordance with teachings of the invention.

FIGS. 7a-e are side elevational views of the punch station of FIG. 6 at various stages of operation.

FIG. 8 is a side elevational view of the inverter of FIG. 4.

FIGS. 9a-b are perspective views of a cover plate of the output stacker at various stages of operation.

FIG. 10 is a fragmentary rear view of the die clamp and lateral die movement mechanism.

FIG. 11 is a fragmentary perspective view of the die throat and die clamp adjustment mechanism.

### DESCRIPTION OF THE PREFERRED EMBODIMENT

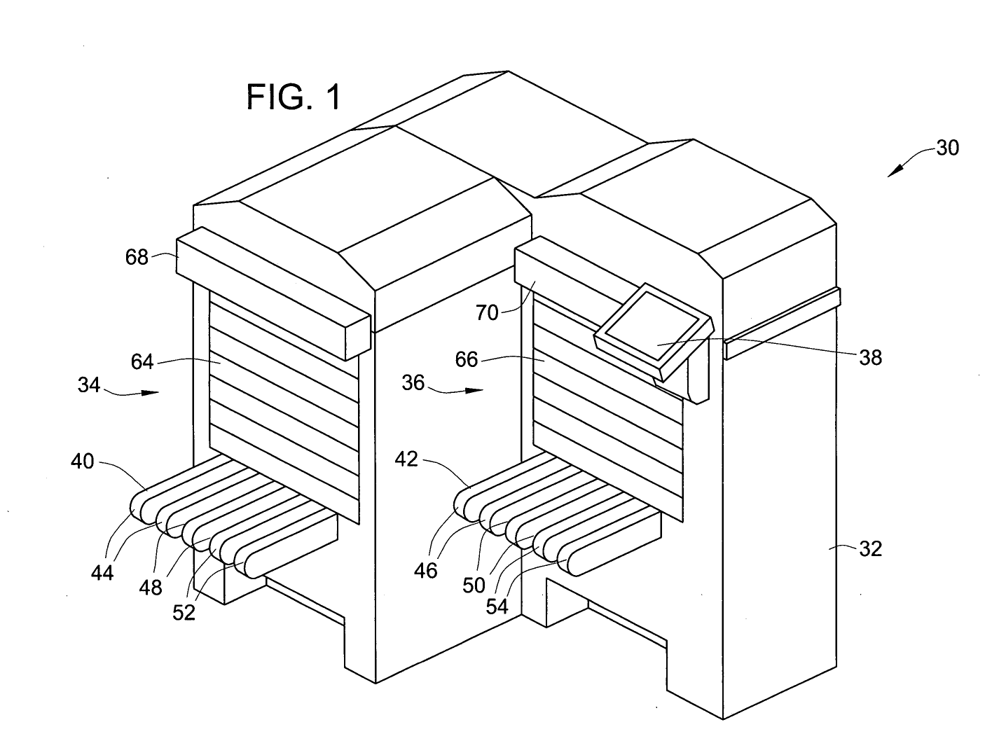

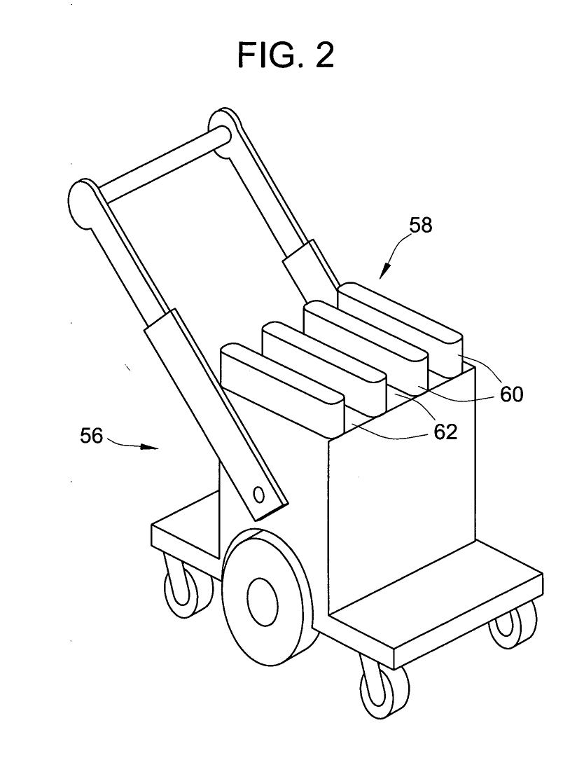

Turning now to the drawings, there is shown in FIG. 1 a punch machine 30 constructed in accordance with teachings of the invention. The machine 30 includes a housing 32 having an input 34 to which a stack of sheets is provided for processing, and an output 36 where the processed stack of sheets may be retrieved. The machine 30 further includes a control panel 38 at which the operator may enter information regarding the processing of the stack of sheets and may read information from the machine regarding the processing of a stack of sheets, as well as given machine settings.

In accordance with the invention, the operator may load a stack of sheets to be processed at the input 34, provide any necessary information regarding the processing of the stack at the control panel 38, and retrieve the processed stack of sheets from the output 36 without any further intervention during the processing. Alternately, the punch may be mated with an automated processing such that it automatically receives a stack of sheets to be punched and delivers the punched stack for further processing. In order to provide for reliable and easy loading and unloading of stacks of sheets from the machine, the machine includes input and output platforms 40, 42. As described in greater detail in Provisional Patent Application No. 60/341,173 filed Dec. 13, 2001, and PCT Application PCT/US0239834 filed Dec. 13, 2002, both of which are assigned to the assignee of the present application and are hereby incorporated in their entirety for all they disclose, the input and output platforms 40, 42 are preferably slotted, having a plurality of alternating platform fingers 44, 46 and platform slots 48, 50. The platforms 40, 42 further include a plurality of individual belts 52, 54 disposed to rotate longitudinally along the outer surface of the platform fingers 44, 46, respectively. To easily move stacks of sheets between the punch machine 30 and other processing modules or storage, a mobile unit or movable cart 56, such as is shown in FIG. 2, may be provided. The structure of the cart 56 is explained in greater detail in U.S. Provisional Application No. 60/341,173 and PCT Application PCT/US0239834. The movable cart 56 comprises a slotted deck 58 having spaced deck fingers 60 and open deck slots 62 spaced and adapted to mate with the fingers 44, 46 and slots 48, 50 of the input and output platforms 40, 42 of the punch machine 30. In this way, stacks of sheets may be transferred between the punch machine 30, platforms 40, 42 and the deck 58 of the movable cart 56. It will be appreciated, however, that alternate mating arrangements may be provided and are within the purview of this invention.

According to an important feature of the invention, stacks of sheets may be supported on both the input and output platforms 40, 42 of the punch machine while actual processing is occurring within the punch machine 30 on a third stack of documents. Moreover, once a stack of sheets to be processed is placed on the input platform 40 and proper information confirmed on or fed into the control panel 38 regarding the stack, no further interface is required from the operator in order to process the stack. That is, once the stack of sheets being processed within the machine 30 is complete, if no other stack is sensed on the output platform 42, the belts 54 will advance the recently completed stack to the output platform 42, and the waiting stack of sheets on the input platform 40 will be automatically received and processed within the machine 30.

To further minimize any opportunity for improper intervention as well as to minimize any opportunity for operator injury, the punch machine 30 includes retractable doors 64, 66 at both the input 34, 36 of the machine 30. The retractable doors 64, 66 are preferably automatically operated such that they open only when a stack of sheets is to be moved in or out of the punch machine 30. In the currently preferred embodiment, the doors 64, 66 are flexible, multipanel doors that are appropriately driven to roll up into door housings 68, 70 provided along the punch machine housing 32. In this way, it will be appreciated that any retaining rolling force on the doors 64, 66 may be released to allow the doors to close merely due to the force of gravity, minimizing the automation required. It will be appreciated, however, that the doors may alternately be opened and closed automatically and that alternate door styles, such as sideways sliding doors, may be provided.

In operation, upon completion of processing a stack of sheets within the machine 30, providing that no processed stack is waiting to be unloaded at the output platform 42, the input and output retractable doors 64, 66 will automatically open, the belts 52, 54 rotated to move a stack of sheets to be processed from the input platform 40 into the machine 30 and a completed stack of sheets out of the machine to the output platform 42. The machine 30 then processes the newly input stack while the operator is free to remove the finished stack from the output platform 42 and load a new stack onto the input platform 40. In the case where no additional stacks will be processed, upon completion of punching a stack, the output retractable door 66 will open. Belts 54 will then be driven to move the completed stack of sheets to the output platform 42, and the retractable door 66 will close. Each of these and other functions of the machine 30 may be controlled by any appropriate arrangement including, for example, a microprocessor or digital control.

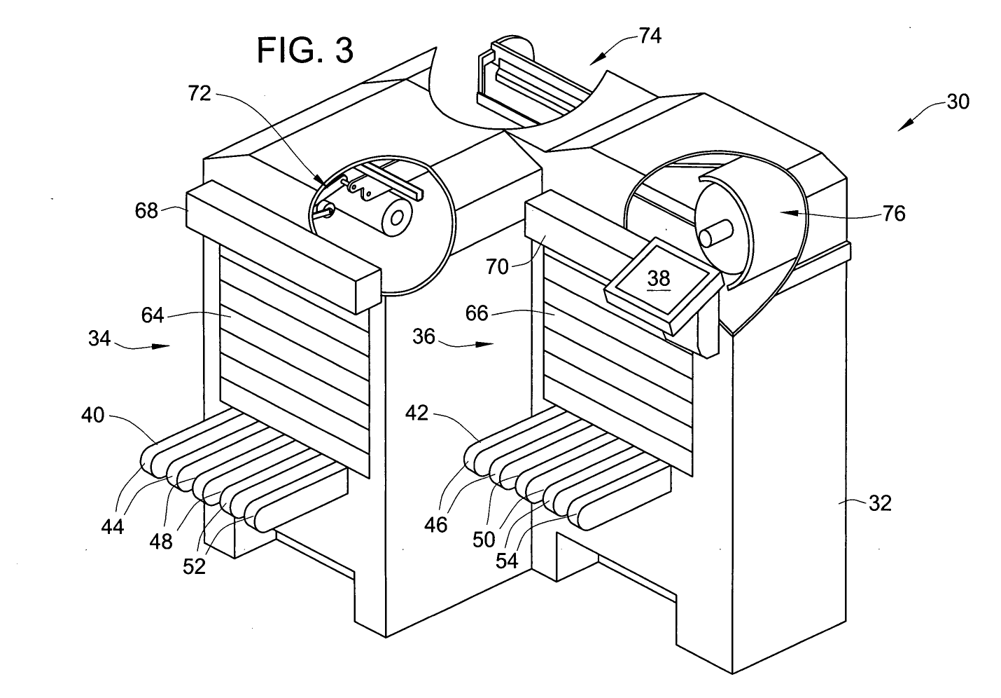

Turning now to the functions performed within the machine itself, as shown at the broken away sections of FIG. 3, the machine includes three stations and transport systems for transporting the documents between those stations. First, to separate a lift from the stack of sheets to be processed, the punch machine 30 includes a pick 72. The picked lift is then transported through the machine to the punch 74, where the punching operation is performed on the lift. The lift is then moved toward the output 36. In order to ensure that the successive processed lifts are presented at the output 36 in the same order as in the initial stack of sheets, the machine 30 is provided with an inverter 76. While any appropriate inverter may be provided, such inverters typically include a rotating barrel which operates in conjunction with a movable belt arrangement that passes the lifts around a portion of the circumference of the barrel and stacks the processed documents face down at an output tray. While the inverter may be of any appropriate design which delivers the successive lifts to an output tray, the presently preferred design is disclosed in more detail in U.S. Provisional Application 60/413,349 filed Sep. 25, 2002, and U.S. Provisional Application 60/374,100, filed Apr. 19, 2002 and subsequently filed as a PCT application on Apr. 17, 2003, which are likewise assigned to the assignee of this application and are hereby incorporated in their entirely for all that they disclose.

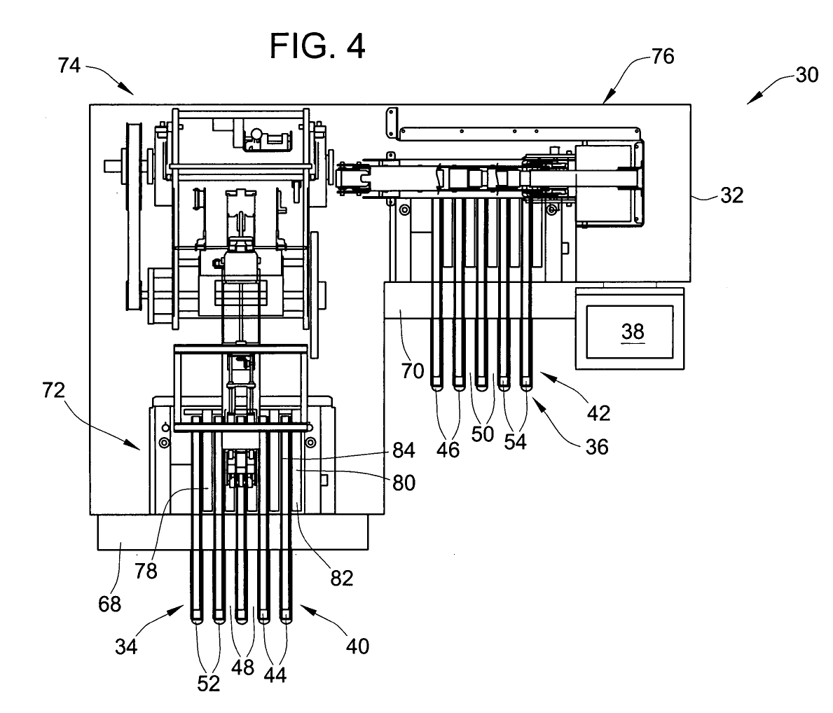

Turning now to a more detailed disclosure of the operation and function of the various components of the punch machine 30, FIG. 4 shows a top plan view of the currently preferred embodiment of the punch machine 30. Upon actuation, the belts 52 of the input platform rotate to move the supported input stack to an input tray 78. In order to lift the stack upward to allow for successive lifts to be taken from the top of the stack, the input tray 78 includes a slotted platform 80 having alternating fingers 82 and slots 84 alternately disposed between the fingers 44 and slots 48 of the input platform 40. In this way, as the slotted platform 80 is driven upward by any appropriate means, the fingers 82 lift the supported stack from the belts 52 extending about the fingers 44. As with the cart 56 and the input and output platforms 40, 42, however, the platform 80 may alternately include any appropriate structure that permits it to elevate the stack of sheets.

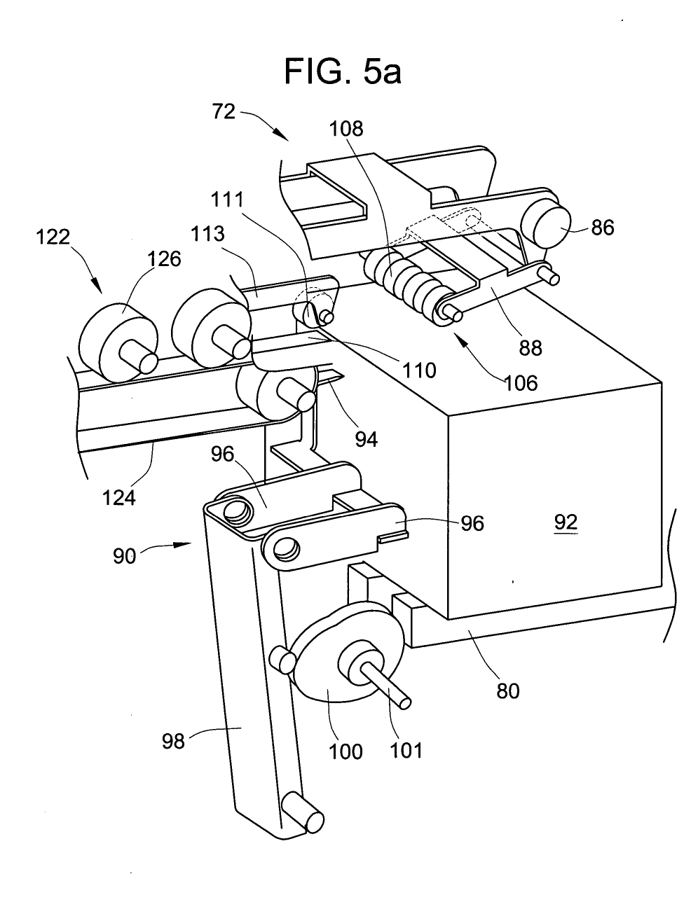

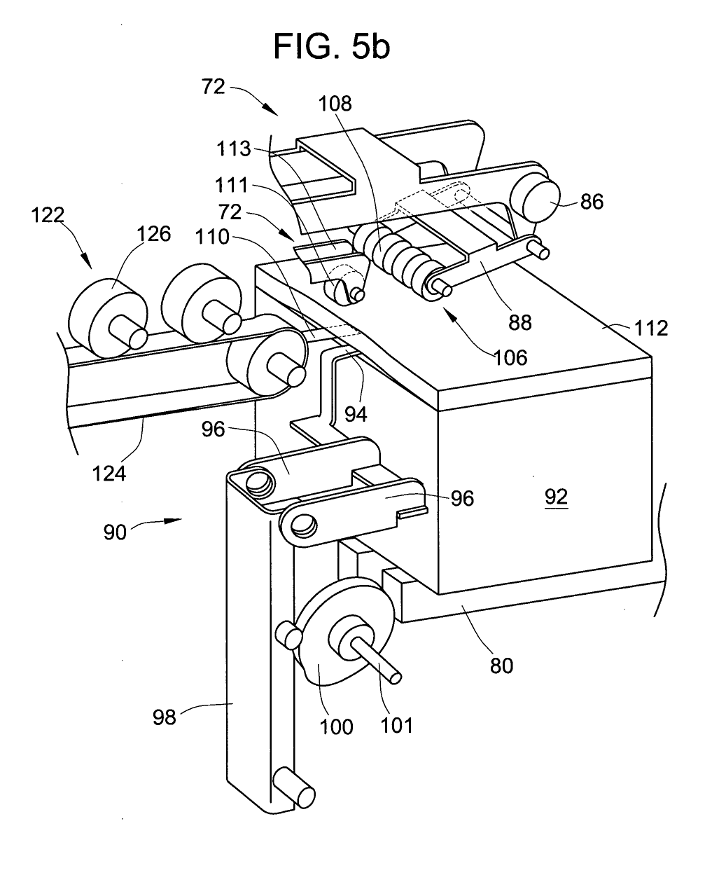

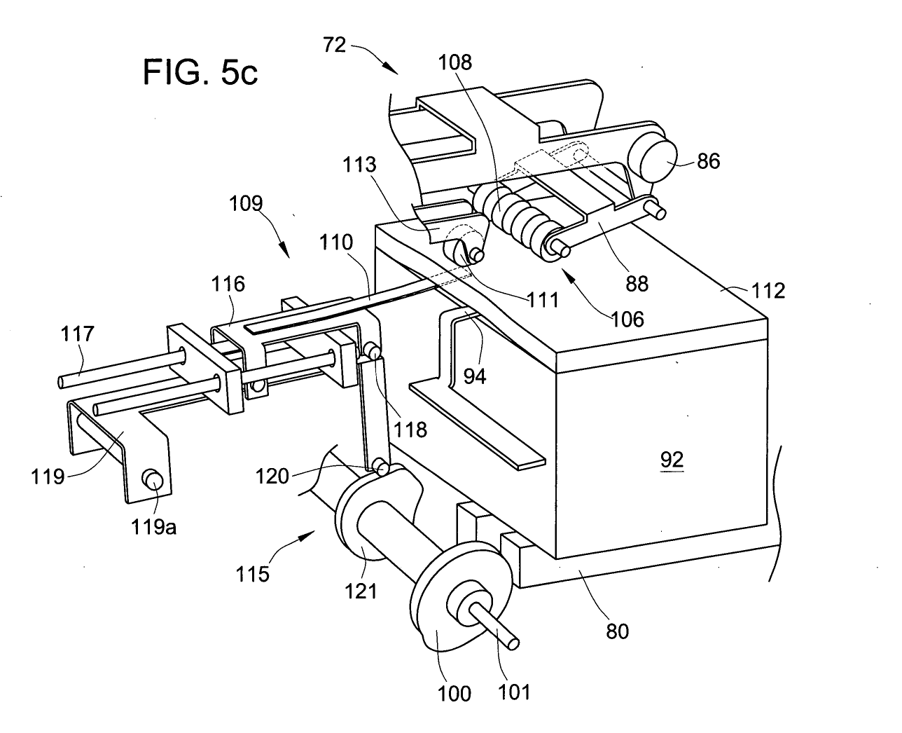

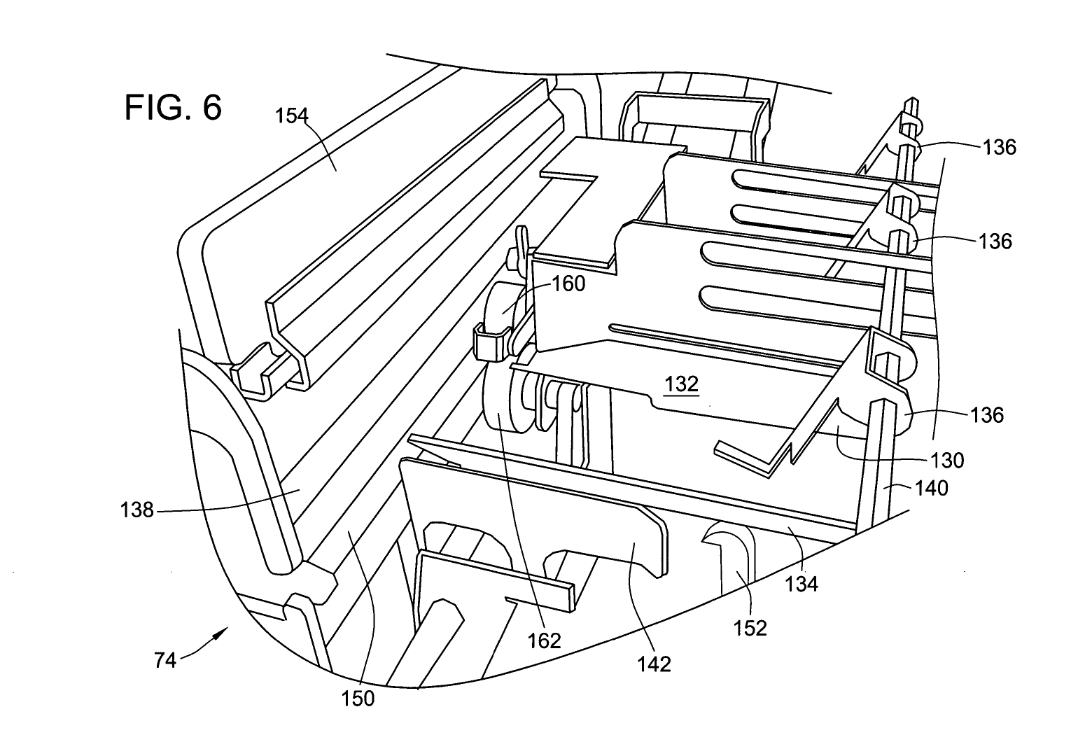

Turning now to FIGS. 5a-d, there is shown a picking device 90 of the pick station 72. The picking device 90 engages the supported stack of sheets 92 to separate a small grouping or lift 112 therefrom for further processing. The size of the lift 112 is dependent upon the various things including settings of the machine as well as the thickness of the paper itself. Typically, lift sizes range from 10-12 sheets. It will be appreciated, however, that the lift size may further range on the order of 2-15 or 20 sheets.

As the slotted platform 80 moves upward, the movement will continue until it reaches proper engagement position for picking, or separation, of lifts therefrom. In this regard, and referring to FIG. 5a, the supported input stack of sheets 92 will continue upward until it reaches and activates an appropriate sensor 86. Here, the input tray elevation sensor 86 is tripped by movement of a pivotably coupled bracket assembly 88. According to a preferred embodiment, the input elevator elevates the platform 80 rapidly at first, and slowing to a desired rate upon reaching the input tray elevation sensor 86. Ideally, the input platform 80 raises at a rate of 1 inch per second until it reaches the sensor 86, at which time the rate of advance slows to a rate dependent upon how many sheets the operator wishes to pick in each lift and how fast the successive lifts will be made. For example, the elevator may raise a distance of 30 thousandths to 50 thousandths of an inch to separate 7-12 sheets of 20 pound bond paper. Alternately, the pick arrangement may include two sensors, the first sensor being tripped to, in essence, zero the system and the second sensor, a Hall Effect sensor measuring the thickness of the lift as the platform 80 continues to move upwards. The pick itself preferably operates on the order of 60 to 120 cycles per minute. In this way, at 60 cycles per minute and at 30 thousandths of an inch lift, the feed rate of the platform 80 will be on the order of 30 thousandths of an inch per second.

Returning now to the operation of the picking device 90 itself, in order to separate a lift 112, the picking device 90 includes a pick 94 preferably centrally disposed along the stack of sheets 92 to engage the edge of the stack of sheets 92 and separate a lift 112 therefrom. (See FIG. 5a; note that a portion of the transport system is broken away to reveal a portion of the pincer assembly 109, as will be explained below.) In the preferred embodiment, the pick 94 is cam operated and moves in an essentially linear motion toward the stack of sheets 92 to separate a lift 112 as shown in FIGS. 5a-b, then away from a stack of sheets to allow the stack 92 to continue its upward movement, then again toward the stack of sheets 92 to separate a successive lift, etc. In this regard, the pick 94 is disposed on a first bracket 96 that is pivotably coupled to a second bracket 98 (see FIGS. 5a-b). The second bracket 98, itself, is pivotably disposed and biased toward a rotatably mounted cam 100. The cam 100 is disposed on a shaft 101, the rotation of which is provided by a series of intermeshing gears coupled to a motor (not shown). In this way, rotation of the cam 100 pivots the second bracket 98 to move the first bracket 96 and associated pick 94 toward the stack of sheets 92.

As shown in FIGS. 5b-c, once the pick 94 has moved into the stack 92 and separated a portion or a lift 112 from the stack 92, a pincer assembly 109 grabs the separated lift 112, and pulls it toward a transport section 122 of the machine 30, which transports the lift 112 on to the punch 76. In the preferred embodiment of the invention, the pincer assembly 109 moves toward the sheet stack 29 concurrently with the picking device 90. The pincer assembly 109 includes a pincer blade 110 adapted to be disposed along the lower surface of the lift 112, and a roller 111 adapted to be disposed along the upper surface of the lift 112. While more than one roller may be provided, here, the roller 111 is mounted to a bracket arrangement 113, preferably by way of a one-way clutch which allows rotation of the roller 111 only in one direction. In the preferred embodiment, the roller 111 is a urethane roller to ensure secure contact with the lift 112. The roller bracket arrangement 113 is mounted for linear movement by any appropriate method, such as on guide shafts (not shown), but is preferably linked to the picking device for movement therewith.

The pincer blade 110 is preferably a relatively flat and thin, elongated blade structure. In the currently preferred embodiment, the pincer blade 110 is approximately one-half inch thick and on the order of 0.076 inch think. In contrast to the roller 111, the pincer blade 110 is mounted to move both linearly and vertically by way of a cam arrangement 115 (see FIG. 5c). Linear movement of the pincer blade 110 is provided by way of a bracket 116 sliding along guide shafts 117. Vertical movement of the pincer blade 110 is provided by way of a second bracket 119, pivotably mounted at 119a. The bracket 116 moves along the top surface of pivotably mounted bracket 119 by way of at least one roller 118. The vertical positioning of the pivotably mounted bracket 119 is determined by a cam follower 120 disposed along the periphery of a cam 121. Conveniently, the cam 121 is mounted to the same cam shaft 101 as the cam 100, which controls movement of the pick 94. In this way, the pincer blade 110 moves forward as the bracket 116 slides along the upper surface of bracket 119. As the cam 121 rotates, the bracket 119 along with bracket 116 and the pincer blade 110 move upward to push the lift 112 toward the roller 111.

Thus, in picking the lift 112, the roller 111 and the pincer blade 110 are driven forward toward the stack 92 to dispose roller 111 above the upper surface of the lift 112 and the pincer blade 110 in the opening created by the pick 94 between lift 112 and the stack of sheets 92 (see FIG. 5c). The pincer blade 110 then moves upward to firmly sandwich the lift 112 between the pincer blade 110 and the roller 111. The separated lift 112, sandwiched between the pincer 110 and the rollers 108, retracts to pull the lift 112 toward the transport section 122 (a portion of which is shown in FIG. 5b) to advance toward the punch station 74. Here, the transport section 122 includes a driven, rotating belt 124 extending along the transport axis. Rotatable rollers 126, four shown here, are disposed such that the belt 124 is subjacently positioned, the rollers 126 and belt 124 forming the lift path toward the punch. While the presently preferred design is described with regard to a particular pick mechanism and transport section, it will be appreciated that alternate arrangements may be provided.

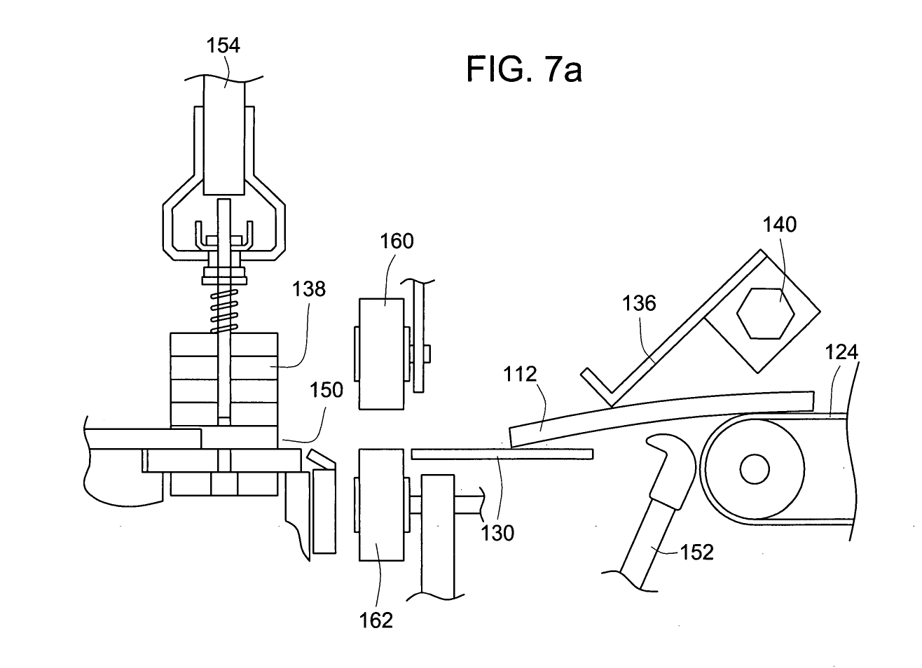

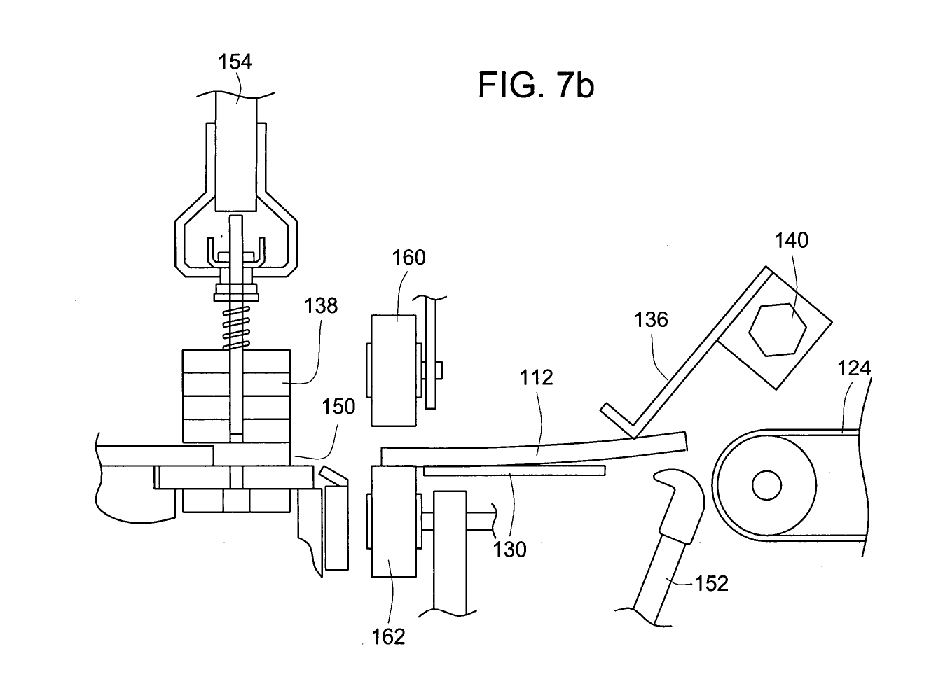

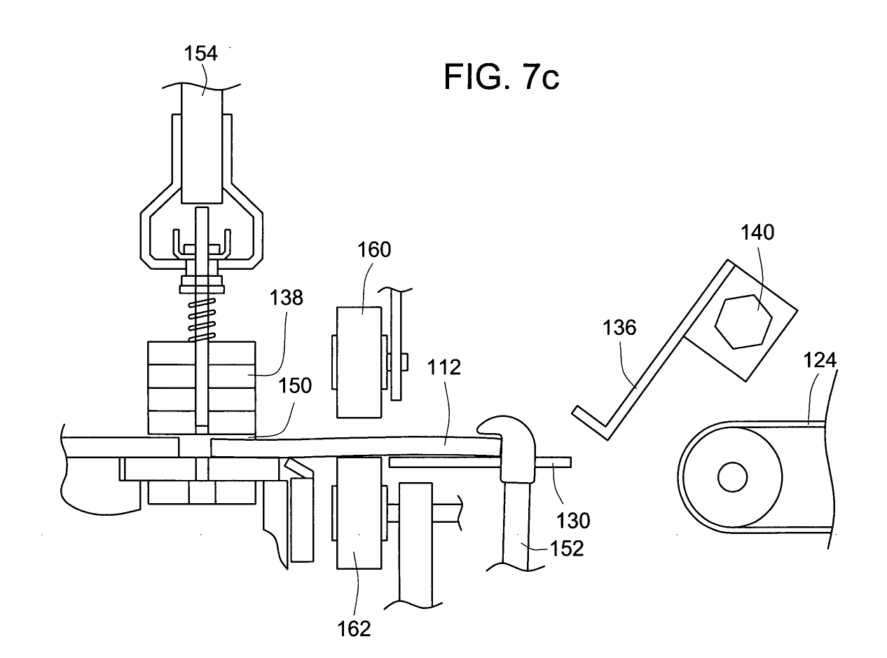

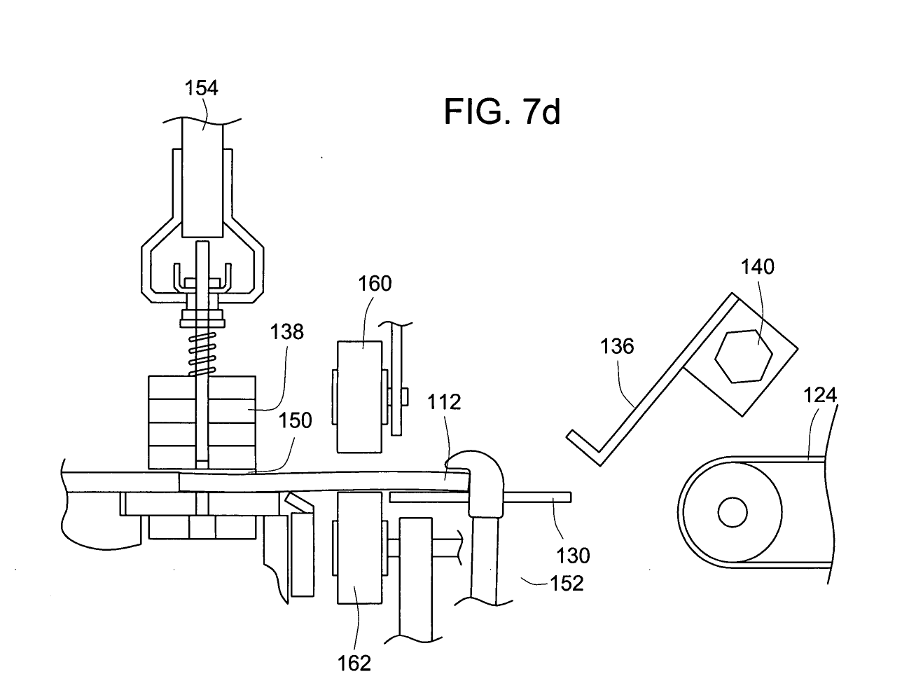

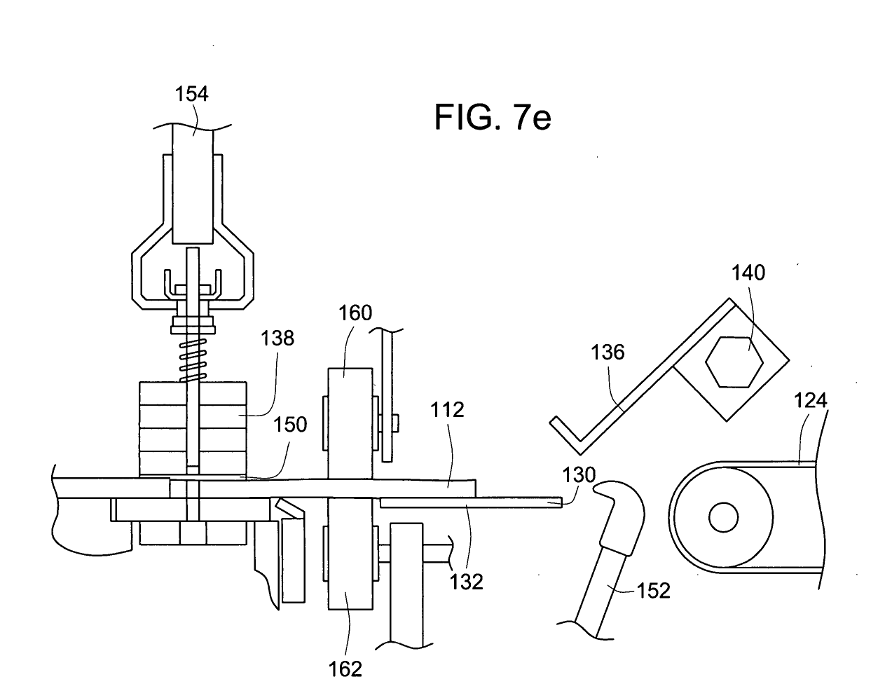

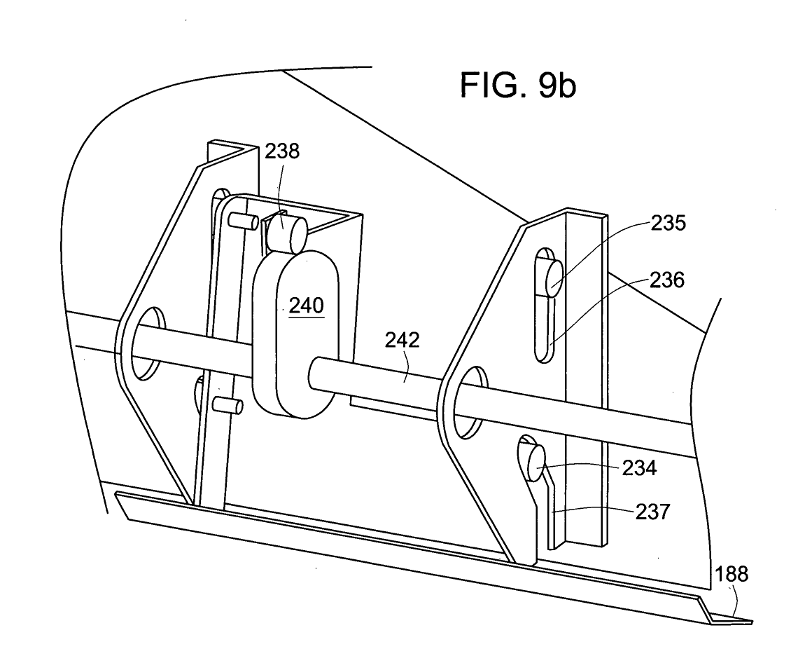

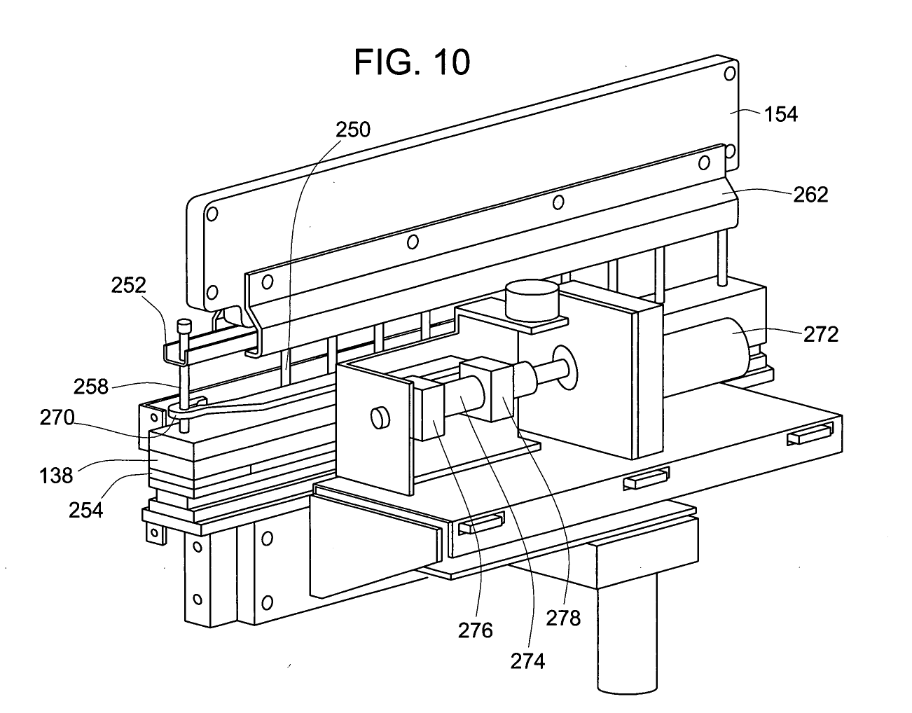

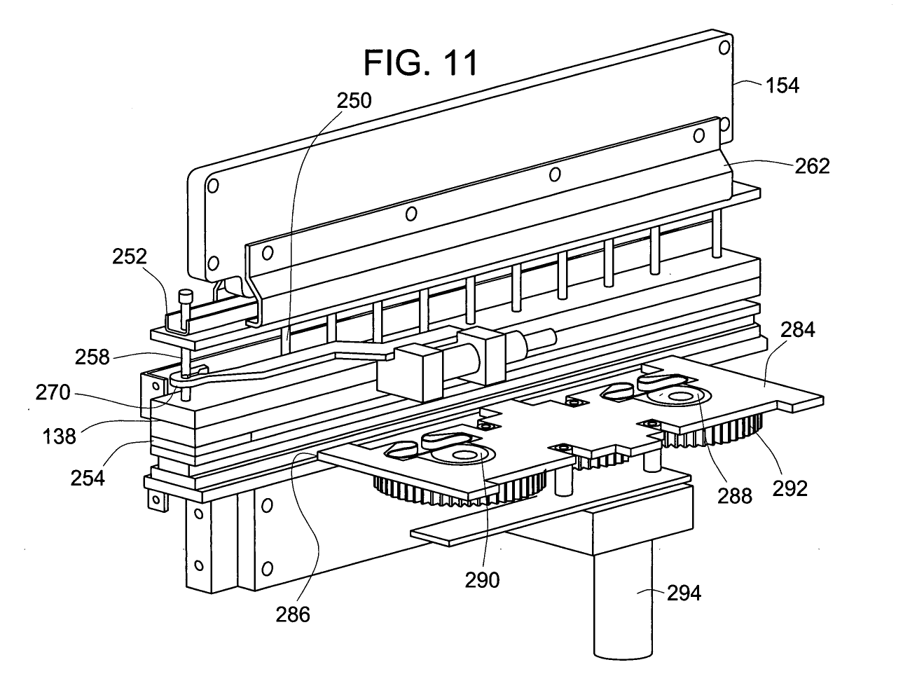

Turning now to FIGS. 6 and 7a-e, the punch station 74 itself includes a die 138 with a throat 150 opening to a platform 130 and a number of arms and surfaces for aligning and moving a lift 112. (It will be noted that, in order to simplify the view shown in FIG. 6 and the explanation thereof, the die set itself is not shown. The reader is referred to FIGS. 10 and 11 and the explanation thereof below for further detail on the design and operation of the die set itself.) As the lift 112 reaches the punch station 74, it drops down into a pocket and is supported on a platform 130 (see FIG. 7b). The platform 130 may be defined by one or more relatively horizontal components, here, a flat surface 132 and one or more elongate bars 134 or the like. To ensure that all sheets of the lift 112 are properly dropped into place on the punch platform 130, kickers 136 are movably mounted to push the rear edge of the lift 112 sheets downward toward the platform 130, as shown in FIG. 7b. Here, the kickers 136 are pivotably mounted on a hex shaft 140 for rotation therewith. It will be appreciated that the kickers 136 may be slidably mounted on the hex shaft 140 to adjust their lateral position relative to the die 138 and the punch platform 130. It will be appreciated that the movement of the kickers 136 along the hex shaft 140 may be performed either manually, or automatically in response to controls indicating the size of the sheets to be punched. In the currently preferred embodiment, the kickers 136 are rotated away from the supported lift 112, but are sprung downward to ensure that the papers are in a complete forward and downward position. This movement of the kickers 136 may be accomplished by a cam or other arrangement.

To provide proper fore/aft alignment of the lift 112 and to force the lift into the throat 150 of the die 138, a plurality of justifiers 152 are provided. As may best be seen in FIGS. 7c-d, the justifiers 152 move linearly forward to push the dropped lift 112 into the throat 152 of the die 138. Preferably, the justifiers 152 have a stroke that is slightly longer than necessary to push the lift 112 into the die 138. In this way, the justifiers “over justify” to ensure proper placement of the lift 112 in the die 138. As with the kickers 136, the justifiers 152 may be adjusted laterally either manually, or automatically in response to controls indicating the size of the sheets to be punched.

As delivered to the punch station 74, the lateral position of the lift 112 may vary considerably. In order to ensure proper centering and accurate punching, alignment plates 142 (see FIG. 6) are provided along either lateral side of the supported lift 112. Once the kickers 136 have ensured that all sheets are properly dropped into the pocket and the justifiers 152 push the lift 112 forward in the throat, the alignment plates 142 raise along either side of the supported lift 112, i.e., they break through the punch plane, and advance inward toward each other to provide lateral alignment of the lift 112. As with the kickers 136 and justifiers 152, one or both of the alignment plates 142 may be laterally adjustable either manually, or automatically in response to controls indicating the size of the sheets to be punched. In the currently preferred embodiment, the outboard alignment plate 142, i.e., the alignment plate visible in the view illustrated in FIG. 6, is laterally adjustable while the other alignment plate disposed at the opposite end of the sheet remains stationary.

The ram 154 is actuated by any appropriate mechanism to apply a closing force to the die 138 and drive the pins through the lift 112 received in the throat 150. As the pins retract, several operations are performed in the punch station 74 to cause the punched lift 112 to move toward the inverter 76. As the punch pins retract, the alignment plates 142 drop outward and downward out of engagement with the stack of sheets. One or more rollers 160, here two rollers, rotatably mounted above the lift 112 move downward to force the lift 112 against driven rollers 162 disposed subjacent the lift 112 (as shown in FIG. 7e). It will be appreciated, however, that the rollers or the like may be alternately arranged such that, for example, the upper rollers are rotatably mounted in a fixed location while the lower rollers advance upward to the engage the sheet(s). The driven rollers 162 preferably have a high friction surface, such as urethane, and are like numbered and disposed below the rollers 160. As the driven rollers 162 rotate, they drive the punched lift 112 laterally from the punch station 74 toward the inverter 76. It may be noted that a subsequent lift entering the punch machine may overlap with a punched lift exiting the punch station 76.

In the preferred embodiment of the invention, the sheet path by which the sheets enter the punch is preferably substantially perpendicular to the sheet path as the sheets exit the punch and move toward the inverter. It will be appreciated by those of skill in the art that the input and output sheet paths may be alternately disposed so long as the sheets still have positive registration at the punch, yet are not required to pass through the punch. While this right angle provides the most desirable registration, the angle between the input and output sheet paths may vary, for example, from approximately 45° to 135°. Alternately, it will be appreciated that many aspects of the invention would likewise be applicable to “pass along” or “pass through” type punch arrangements.

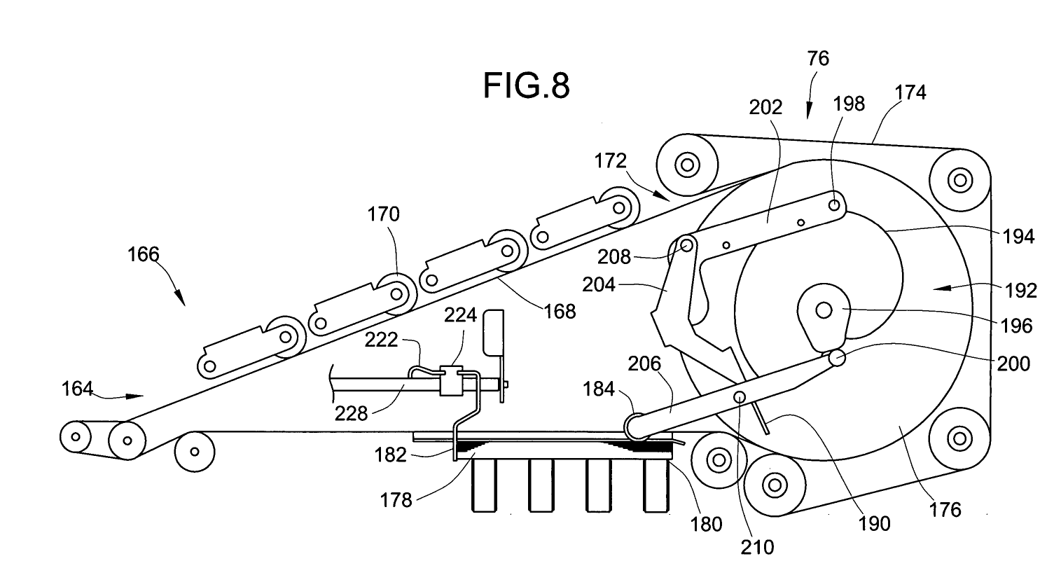

As the driven rollers 162 advance the punched lift 112 laterally, it is received in a nip 164 formed at yet another transport arrangement 166. As illustrated in FIG. 8, the transport 166 to the inverter 76 includes an elongated, driven belt 168 disposed subjacent the lift 112, and a plurality of rollers 170 disposed above the lift 112. The lift 112 proceeds to a nip 172 disposed between the belt 168 and a second belt 174 such that the lift 112 proceeds around a portion of the circumference of the inverter drum 176 to invert each individual lift 112 and release it in a facedown configuration on an output stack 178 supported on an output tray 180. The output tray 180 continues to move downward as the thickness of the supported output stack 178 increases.

As the inverted lift exits the belts 168, 174 at the drum 176, the momentum of the moving lift causes it to hit the side plate 182 of the output tray 180 before settling onto the output stack 178. In order to minimize any springback resulting from the lift hitting the side plate 182, one or more high friction, one-way rollers 184 are disposed along the upper surface of the lift as it exits the turnover drum 176. In this way, the high friction surface of the rollers 184 prevents or minimizes springback, while the one-way rotation of the rollers 184 allows the forward movement of the lift.

In order to further ensure alignment of the trailing edge of the lift leaving the inverter 76, one or more side justifiers 190 are provided opposite the side plate 182 of the output tray 180. Following each lift, the side justifiers 190 pivot toward the output stack 178 and square up the edge of the stack closest to the inverter 76. As may be seen in FIG. 8, the side justifiers 190 and the high friction one-way rollers 184 are mounted by of a cam arrangement 192 to the shaft of the rotating inverter drum 176. Those of skill in the art will appreciate that in this embodiment the cam arrangement 192 includes two sizes of cams 194, 196, two cam followers 198, 200, and a series of brackets 202, 204, 206 pivotably coupled at pivot joints 208, 210. More particularly, cam follower 198 follows the rotating nautilus-shaped cam 194. The cam follower 198 is coupled to L-shaped bracket 202, pivotably mounted to bracket 204. While one end of bracket 204 is pivotably mounted to the L-shaped bracket 202 at joint 208, the opposite end of the bracket 204 is pivotably coupled at joint 210 to the bracket 206 supporting the high friction one-way rollers 184. The end of the bracket 206 opposite the rollers 184 includes the cam follower 200, which is disposed to follow cam 196, rotating with the drum 176 shaft. In this way, as the shaft of the inverter drum 176 rotates, the cam and linkage arrangement 192 will cause the one-way rollers 184 to move to a position in which it first allows the lift to exit the inverter 76, but then resists the reverse movement of the lift as a result of springback, and compels the lift toward the output stack 178. As the drum 176 and cams 196, 198 continue, the justifiers 190 are moved toward the trailing edge of the output stack 178 to square any wayward sheets.

The side plate 182 may be adjusted by any appropriate means in order to accommodate various paper sizes. In the embodiment illustrated, the side plate 182 includes a bracket 222 having a threaded section 224 movably disposed along a threaded rod 228, which is rotatably mounted and driven to adjust the location of the bracket 222 and, accordingly, the side plate 182. As with the kickers 136, justifiers 152, and alignment plates 142, the side plate may be adjusted either manually, or automatically in response to controls indicating the size of the sheets to be punched.

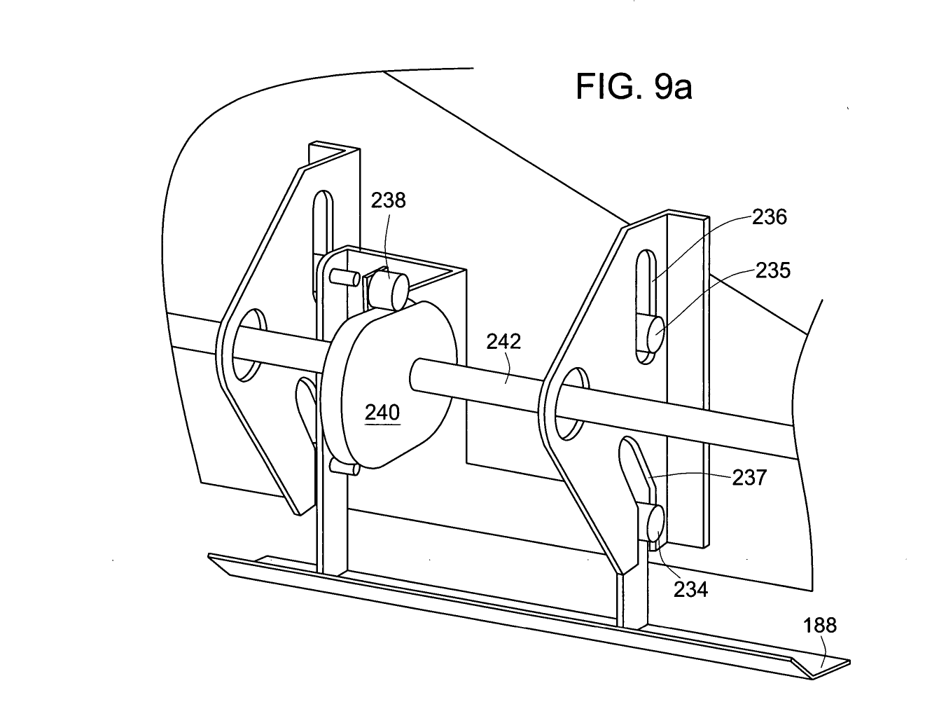

As may be seen in FIGS. 9a-b, to minimize the possibility of the exiting lift snagging on any paper flash around the perforations in the punched sheets, the output stacker includes a movably mounted cover plate 188. The cover plate 188 is cam or otherwise operated to move between a retracted position and an engaged, compressing position. In this way, the cover plate 188 is disposed to cover the perforation edge of the stack as the subsequent individual lift exits the inverter 76 to be positioned on the output stack 178. Once the lift is situated on the output stack 178, the cover plate 188 retracts from engagement with the output stack 178, moves slightly upward and again inward toward the stack and downward along the stack edge covered perforations in preparation for receiving the next lift exiting the inverter 176. It will further be appreciated by those skilled in the art that the downward force applied on the output stack 178 along the perforation edge further acts to minimize any stack height differential that may result from any flash around the holes in the sheets.

The movement of the perforation cover plate 188 is likewise determined by rotating rods and a cam arrangement. More particularly, the movement of the perforation cover plate 188 is determined by pins, or followers 234, 235 disposed in slots 236, 237. It will be noted that the upper slots 236 are relatively straight, while the lower slots 237 have an S-shape or an offset. In this way, as the perforation cover plate 188 moves upward and the pins 234 reach the offset end of slots 237 (see FIG. 9b), the perforation cover plate will move outward in addition to moving upward. The upward movement of the perforation cover plate 188 is provided as cam follower 238 follows the edge of cam 240. As shown, cam 240 is mounted for rotation with shaft 242. Shaft 242 is further driven for rotation directly off of the shaft of the inverter drum 176 or other appropriate mechanism.

Thus, the punch machine provides a highly automated punching and processing arrangement that requires minimal intervention and input by an operator. This minimal input consequently minimizing the opportunity for operator or other error with regard to the processing instructions. In keeping with these primary objectives, the punch station 174 includes features which allow the automatic adjustment of and positioning of the die set 138.

As shown in FIGS. 10-11, a die set 138 typically includes a plurality of die pins 250 disposed through a die pin retainer 252 that is movable with respect to a plurality of die plates 254 having openings therethrough (not visible in these views) for receiving the die pins 250. Guide pins 258 disposed as opposite ends of the die set 138 control the relative sliding movement of the die pin retainer 252 to the die plates 254. In accordance with the invention, the die set 138 includes an engagement structure, the significance of which will be explained below. In the illustrated embodiment, the guide pin 258 acts as the engagement structure or shaft. The die set 138 itself is slidingly received in the punch station 174 by brackets 262 extending from the ram 154, which receive the die pin retainer 252, and a channel, which receives the die plates 254. The die set may be alternately received, however, by, for example, one or more rollers, conveyors, rails, trolleys, or by a magnetic arrangement.

In order to provide for automated adjustment of the lateral position of the die set 138 within the machine 30, as well as the depth of the die throat 150, the punch station 74 further includes an arrangement for reading the die set 138 to determine its arrangement, size, etc., and adjusting the lateral location of a die set 138 and depth of the die throat 150. To this end, there is provided a mating engagement structure, here, a detent, or hook 270 which receives the engagement shaft 258, and effectively locks thereto. This engagement and locking may be obtained as a result of the operator sliding the die set 138 into position and physically causing engagement, or the punch station 74 may be provided with a mechanism by which the machine physically continues sliding the die set 138 into the engagement position. In any event, once the engagement shaft 258 is secured to the hook 270, the machine 30 automatically activates to draw the die set 138 in across a bar code reader or other identifying mechanism. The die set 138 identifying marker may include alternate structure, such as, for example, a radio frequency tag or an array of mechanical switches. In this regard, movement of the hook 270 is provided by a small motor 272 or other means to rotate the threaded shaft 274 (see FIG. 10). The hook 270 is coupled to the threaded shaft via threaded bearings 276, 278. In this way, as the motor 272 rotates the threaded shaft 274, the threaded bearings 276, 278 along with the hook 270 secured thereto cause a lateral movement of the die set 138.

Once the machine has recorded the die set pertinent information and the paper size to be punched, the machine digitally determines and moves the die set 138 to the appropriate lateral position. It will thus be appreciated by those of skill in the art that by moving the position of the die set 138 itself, the machine eliminates the necessity of any repositioning of the alignment features related to the feeding of the individual lifts themselves. It is to be noted that, in some punch and paper configurations, some pins may require manual pulling from the die set 138. Under these circumstances, inasmuch as the machine has processed data related to both the die set and paper configurations, the instructions for pulling said pins may optionally be displayed on the control panel 38 or an alternate control panel on the machine.

It will be appreciated by those of skill in the art that such a slide arrangement for receiving the die set 138 relative to the ram 154, the centerline of the plurality of die pins 250 will always be disposed along substantially the same ram position in the machine. That being the case, under certain conditions, it may be desirable to adjust the distance of the resulting punched holes from the edge of the paper. In accordance with an important feature of the invention, the depth of the throat 150, which determines the aftmost position of the lift in the die set 138, may be adjusted. Referring to FIG. 11, there is provided a throat back plate 284, the forward surface 286 of which will determine the depth of the throat 150 as the throat back plate 284 slides between die plates 254 disposed along either side of the throat 150. The fore and aft movement of the throat back plate 284 is determined by cams 288, 290 received in openings in the back plate 284. Rotation of the cams 288 themselves is provided by way of a gearing arrangement 292 coupled to a motor 294. Those of skill in the art will appreciate that any appropriate gearing arrangement may be utilized to rotate the camming arrangement, and, alternately, any appropriate arrangement may be provided to move the back plate 284 toward or away from the throat 150 to adjust the distance of the resulting punched holes from the edge of the page. For example, a rack and pinion arrangement, a threaded shaft arrangement or alternate non-mechanical movement arrangement may be provided. Thus, having determined the die and paper configuration, the signals provided to the motor 294 rotate the gearing arrangement 292 in the illustrated embodiment to so position the cams 288 and 290 of the back plate 284, providing a desired depth of the die throat 150 to the forward surface 286 of the back plate 284. Following this automatic adjustment, if a mispunch is observed by the operator, the operator can make some manual adjustments, including adjustment of the lateral die position by manually overriding the machine and then allowing the machine to reclamp the die set 138 in the desired position. The back plate 284 additionally, or alternately may be utilized as a clamp for retaining the die set 138 in position.

In summary, the automated punch machine provides a fully automated, digital machine for processing stacks of sheets. Minimal to no user interface is required during the actual processing of a stack. Upon entering or otherwise reading the paper size, by sensors or the like, various elements of the punch machine, such as the kickers 136, the justifiers 152, the alignment plates 142, the die set 138, the back plate 284, and the side plate 182 may be automatically or digitally adjusted in response to controls indicating the size of the sheets to be punched, thus providing a compete digital set up. Further, the machine provides a buffering system in that successive stacks of sheets may be processed without user intervention.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An automatic sheet stack processing system for punching perforations in sheets from a first stack of said sheets and from a second stack of said sheets to provide perforated sheets, the system comprising
an input platform for supporting said first stack of sheets,
an output platform for supporting said perforated sheets,
a punch,
an input sheet path disposed between the input platform and the punch,
an output sheet path disposed between the punch and the output platform,
automated controls for causing the movement of successive sheets from the input platform along the input sheet path to the punch, and from the punch along the output sheet path to the output platform, and
at least one of the input platform or the output platform comprising a substantially horizontally extending portion disposed to support the second stack of said sheets while the first stack of said sheets is being punched.

2. The automated sheet stack processing system of claim 1 wherein the input sheet path comprises a pick disposed to pick successive lifts of sheets from a stack of sheets supported on the input platform and to move said successive lifts toward the punch.

3. The automated sheet stack processing system of claim 1 wherein the output sheet path comprises an inverter disposed to invert sheets moving along the output sheet path and onto the output platform.

4. The automated sheet stack processing system of claim 1 further comprising a housing having an inlet and an outlet.

5. The automated sheet processing system claim 4 further comprising at least one of an input door or an output door.

6. The automated sheet processing system of claim 4 wherein said horizontally extending portion extends outward from the housing through the inlet or outlet.

7. The automated sheet processing system of claim 1 wherein the punch comprises a die set and the input sheet path adjacent the die set is disposed at an angle to the output sheet path adjacent the die set, the angle being between substantially 45° and 135°.

8. The automated sheet processing system of claim 7 wherein the angle is between substantially 80° and 100°.

9. The automated sheet processing system of claim 1 wherein at least a portion of the input platform is mounted to move in a substantially vertical direction, and the system further comprises at least one sensor disposed to detect the movement of the stack of sheets disposed on the input platform whereby the thickness of a lift from the stack of sheets may be determined.

10. The automated sheet processing system of claim 9 further comprising at least a pair of sensors disposed to detect the thickness of the lift and wherein the substantially vertical movement of the input platform is dependent upon the desired thickness of the lift.

11. The automated sheet processing system of claim 1 further comprising at least one sensor disposed to sense sheets disposed on the output platform.

12. The automated sheet processing system of claim 1 further comprising at least one adjustable sheet controlling structure, said sheet controlling structure being adjustable to accommodate different sizes of sheets.

13. The automated sheet processing system of claim 12 wherein the adjustable sheet controlling structure comprises at least one alignment plate for squaring the sheet in the punch.

14. The automated sheet processing system of claim 12 wherein the adjustable sheet controlling structure comprises at least one justifier disposed to exert a force on the sheet in the punch to ensure proper seating.

15. The automated sheet processing system of claim 12 wherein the adjustable sheet controlling structure comprises at least one kicker disposed to exert a force on the sheet in the punch to ensure proper seating.

16. The automated sheet processing system of claim 12 wherein the adjustable sheet controlling structure comprises at least one side plate disposed substantially adjacent the output platform.

17. The automated sheet processing system of claim 12 wherein the punch further comprises a die set and wherein the adjustable sheet controlling structure comprises structure to adjust the position of the die set within the punch.

18. The automated sheet processing system of claim 12 wherein the punch further comprises a die set comprising a throat for receiving said sheet and wherein the adjustable sheet controlling structure comprises structure to adjust a depth of the throat.

19. The automated sheet processing system of claim 1 further comprising a handling cart, said handling cart and at least one of said input or output platforms comprising mating structure whereby said stack of sheets may be transferred between the cart and at least one of the input or output platform.

20. A method for punching perforation in sheets from an input stack of sheets, said method comprising the steps of
positioning the input stack of sheets on an input platform of an automated punch machine,
feeding successive lifts of sheets from said input stack to a punch,
punching said successive lifts,
stacking said punched successive lifts in an output stack,
removing said output stack from the automated punch machine, and
at least one of the steps of
positioning a second input stack of sheets on the input platform while the feeding step is performed, or
moving the output stack to an output platform and feeding a second stack of sheets prior to removing the output stack from the output platform.

21. The method of claim 20 wherein step of feeding said input stack comprises the step of placing the input stack of sheets on an input platform.

22. The method of claim 21 wherein the step of feeding a stack comprises the further step of opening an input door and advancing said input stack into a feeding position.

23. The method of claim 21 wherein the step of feeding successive lifts comprises the steps of elevating said input platform and sensing the movement of said platform to determine an optimal lift thickness.

24. The method of claim 20 wherein the step of feeding successive lifts further comprises the step of picking a lift from the input stack of sheets.

25. The method of claim 20 wherein the step of feeding the successive lifts comprises the step of moving the successive lifts along an input path, and the step of stacking said punched successive lifts in an output stack comprises the step of moving the successive lifts from the punch to said output stack, wherein at least a portion of the input path is disposed at an angle to the output path of between substantially 45° and 135°.

26. The method of claim 25 wherein the angle is between substantially 800 and 100°.

27. The method of claim 20 wherein the stacking step comprises the step of inverting said punched successive lifts onto said output stack.

28. The method of claim 20 wherein the step of stacking said punched successive lifts comprising the step of sensing the sheets on the output stack.

29. The method of claim 20 wherein the step of removing said output stack comprises the step of advancing the output stack out of said automated punch machine.

30. The method of claim 20 wherein the step of removing said output stack comprises the step of opening an output access door.

31. The method of claim 20 further comprising the step of loading a die set into said punch machine, reading the die set, and adjusting the position of the die set within said punch machine based upon said reading of the die set.

32. The method of claim 31 wherein the step of reading the die set and adjusting the position are automatically done.

33. The method of claim 31 wherein the step of reading the die set comprises the step of reading a dedicated identifying marker on the die set.

34. The method of claim 33 wherein the dedicating identifying marker comprises a bar code.

35. A punch machine for punching at least one sheet, said punch machine comprising
at least one die set, said die set comprising a dedicated identifying marker,
structure disposed to receive said die set for actuation within said punch machine, and
an automated reading arrangement disposed to read said identifying marker on said die set.

36. The punch machine of claim 35 wherein said bracket comprises a track disposed to slideably receive said die set.

37. The punch machine of claim 36 wherein the automated reading arrangement is disposed to read the dedicated identifying marker as the die set is slid into the track.

38. The punch machine of claim 35 wherein the die set comprises a throat for receiving said sheet for punching, and the machine further comprises at least one back plate disposed to be received in said throat, said back plate within the throat determining a depth of the throat for receiving the sheet.

39. The punch machine of claim 38 wherein at least one of the back plate and the die set are moveably mounted relative the other to adjust the depth of the throat.

40. The punch machine of claim 39 wherein the depth of the throat is automatically adjusted based upon the dedicated identifying marker.

41. The punch machine of claim 35 wherein the position of the die set within punch machine is automatically adjusted based upon the dedicated identifying marker.

42. The punch machine of claim 35 further comprising a controller, said controller being disposed to adjust a position of the die set in the machine based upon a reading of said dedicated identifying marker.

43. The punch machine of claim 38 further comprising a controller, said controller being disposed to adjust a position of at least one of the die or the back plate.

44. The punch machine of claim 35 wherein the dedicated identifying marker comprises a bar code and the automated reading arrangement includes a bar code reader.

45. The punch machine of claim 35 wherein the dedicated identifying marker comprises a radio frequency tag.

46. The punch machine of claim 35 further comprising at least one adjustable sheet controlling structure, said sheet controlling structure being adjustable to accommodate different sizes of sheets.

47. The punch machine of claim 46 wherein the adjustable sheet controlling structure comprises at least one alignment plate for squaring the sheet in the die set.

48. The punch machine of claim 46 wherein the adjustable sheet controlling structure comprises at least one justifier disposed to exert a force on the sheet in the die set to ensure proper seating.

49. The punch machine of claim 46 wherein the adjustable sheet controlling structure comprises at least one kicker disposed to exert a force on the sheet in the punch to ensure proper seating.

50. The punch machine of claim 46 wherein the adjustable sheet controlling structure comprises at least one side plate disposed substantially adjacent the output platform.

51. The punch machine of claim 46 wherein the adjustable sheet controlling structure comprises structure to adjust the position of the die set within the punch.

52. The punch machine of claim 46 further comprising a throat for receiving said sheet and wherein the adjustable sheet controlling structure comprises structure to adjust a depth of the throat.

53. The punch machine of claim 46 further comprising a handling cart, said handling cart and at least one of said input or output platforms comprising mating structure whereby said stack of sheets may be transferred between the cart and at least one of the input or output platform.

54. The punch machine of claim 35 wherein the dedicated identifying structure comprises a mechanical array of switches.

55. The punch machine of claim 35 wherein the structure comprises at least one bracket.

56. The punch machine of claim 35 wherein the structure comprises at least one roller.

57. The punch machine of claim 35 wherein the structure comprises at least one conveyor.

58. The punch machine of claim 35 wherein the structure comprises at least one magnet.

59. The punch machine of claim 35 wherein the structure comprises at least one rail.

60. The punch machine of claim 35 wherein the structure comprises at least one trolley.

61. The method of claim 20 wherein the step of providing comprises the step of maneuvering a cart to provide the input stack, and the step of removing comprises the step of maneuvering said cart to remove the output stack.

62. A method of processing a stack of sheets comprising the steps of
maneuvering a cart to feed said stack of sheets to an automated punch machine, said stack of sheets not being surrounded by a cassette,
mating cooperative structure of the cart with cooperative structure on an input platform,
feeding successive lifts through the automated punch machine to a die set,
punching perforations in successive lifts,
stacking the perforated successive lifts on an output platform,
maneuvering said cart to mate cooperative structure of the cart with cooperative structure on the output platform, and
removing the perforated lifts from the output platform.
